(19) United States
(12) Patent Application Publication
(10) Pub. No.: US 2013/0027724 A1
(43) Pub. Date: Jan. 31, 2013

(54) PRINTER

(71) Applicants: Yu Zhao, Singapore (SG); Saurabh Garg, Singapore (SG); Chuf Hof Loo, Singapore (SG)

(72) Inventors: Yu Zhao, Singapore (SG); Saurabh Garg, Singapore (SG); Chuf Hof Loo, Singapore (SG)

(21) Appl. No.: 13/192,358

(22) Filed: Jul. 27, 2011

(51) Int. Cl. G06K 15/02

(52) U.S. Cl. 358/1.13; 358/1.15

(57) ABSTRACT

Printer including a controller and a communication circuit for receiving a communication in a low power mode. In an example, the communication activates a deactivated controller and/or transmits content of the communication to the controller.

### BACKGROUND

Printers are provided with a printer controller for receiving, processing and sending signals from and to the various printer components for printing. Some printers consume no power or a low amount of power when the printer is switched off, and a high amount of power when the printer is switched on. The printer needs to be switched on to be able to receive instructions for printing.

### BRIEF DESCRIPTION OF THE DRAWINGS

For the purpose of illustration, certain examples of the present invention will now be described with reference to the accompanying drawings, in which:

FIG. 1 shows a diagram of an example of a printer and a communication source;

FIG. 2 shows a diagram of an example of a printer and a communication;

FIG. 3 shows a diagram of an example of a communication circuit and a controller;

FIG. 4 shows a flow chart of an example of a method of printing; and

FIG. 5 shows a flow chart of another example of a method of printing.

### DETAILED DESCRIPTION

In the following detailed description, reference is made to the accompanying drawings. The examples in the description and drawings should be considered illustrative and are not to be considered as limiting to the specific example or element described. Multiple examples may be derived from the following description and/or drawings through modification, combination or variation of certain elements. Furthermore, it may be understood that also examples or elements that are not literally disclosed may be derived from the description and drawings by a person skilled in the art.

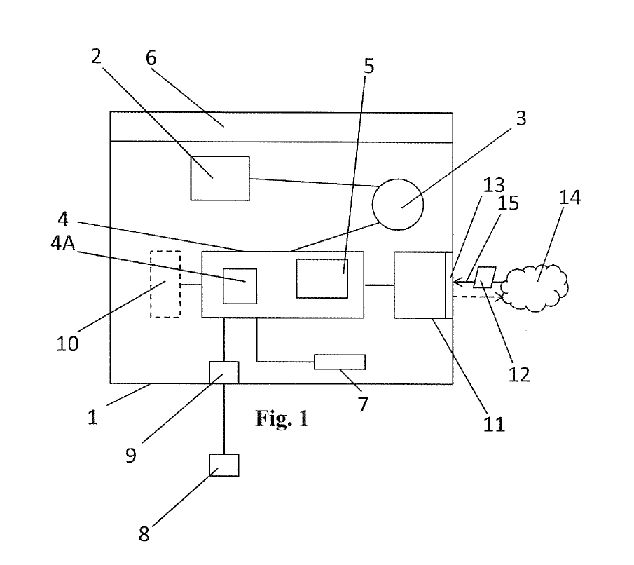

FIG. 1 shows an example of a printer 1. The printer 1 may be a multi-functional printer. For example, the printer 1 may be arranged to handle multiple functions including at least printing, and at least one of faxing, image scanning, communicating through internet, copying, etc. In the shown example, the printer 1 includes a scanner 6. The printer 1 may function as a peripheral device, i.e. connected to a computer, and/or as a stand-alone device. The printer 1 includes an imaging device 2, for example an inkjet printhead and/or a toner imaging assembly. The imaging device 2 may include ejection elements such as resistors and/or heaters and/or piezo elements. In a further example, the imaging device 2 includes a carrier for receiving a replaceable ink or fluid supply. The printer 1 includes a drive system 3 for driving media through the printer 1. The drive system 3 may also be used to drive the imaging device 2. For example, the drive system 3 may include at least one motor, for example for scanning a scanning part of the imaging device 2, rotating a rotating part of the imaging device 2, driving pumps etc.

The printer 1 includes a controller 4. The controller 4 may include a processing circuit 4A and a memory 5. The controller 4 is configured to instruct the drive system 3 and the imaging device 2. For example, the controller 4 is configured to instruct the imaging device 2 to print an image based on digital image data. In an example, the controller 4 is an Application Specific Integrated Circuit (ASIC). In an example the controller 4 includes an analogue and a digital circuit, for example an analogue ASIC and a digital ASIC. For example, the analogue ASIC includes motor drives, regulators, etc. The digital ASIC may include or be connected to a data interface 10, referred to herein as second data interface 10, which in this example may be an interface arranged to receiving at least digital image data for printing. For example, the second data interface 10 is arranged to connect to a network, host device and/or memory module such as memory sticks, etc. The second data interface 10 may be configured to connect wirelessly and/or through a connected line.

The printer 1 includes a memory 5. The memory 5 may be a non-volatile storage device. In an example, the memory 5 is part of the controller 4. The printer 1 includes an on/off switch 7. In an example, the switch 7 is arranged to switch on or cut off a power to the controller 4. In a further example, the switch 7 is arranged to partially and/or completely deactivate the controller 4, for example to facilitate setting the printer 1 in a sleeping, a stand-by or an off-mode. The switch 7 may be arranged to switch the printer 1 in multiple low power modes. The switch 7 may be of any type. For example, the switch may comprise a resistor or photo sensor type touch button, a physical push button, etc.

The printer 1 and the controller 4 are connected to a first power source 8, such as an AC socket providing a voltage of approximately 200 to 240V, or 100 to 120 Volts. In an example, the printer 1 includes an adaptor 9 for the incoming power, for example a 32 Volts AC to DC Adaptor. The adaptor 9 is arranged to adapt the incoming current signal for the printer's controller 4.

The example printer 1 includes a communication circuit 11. The communication circuit 11 is configured to receive and transmit a communication 12. In this communication, a communication 12 is a signal that enters the communication circuit and that when processed represents a message to a human user. The communication 12 may include printable content, for example a fax message.

The communication circuit 11 includes a communication circuit interface 13 arranged to connect to a communication source 14 outside of the printer 1. For example, the communication circuit interface 13 includes a line connector for connecting to a line 15 or a wireless interface for connecting to the communication source 14. The communication source may be a communication transmission arrangement for transmitting communications from another source. For example, the communication source 14 is a phone circuit such as a landline, for example as present in a building. For example, the communication circuit 11 is a fax circuit or modem and the communication 12 includes a fax message or other coded message. For example, the communication circuit interface 13 includes an extension line pickup and a line out, to transmit incoming phone calls to an external telephone. In an example the second interface 10 and the communication circuit interface 13 are integrated or may be part of a common interface.

For example, the communication source 14 functions as a second power source. The communication source 14 may provide a power to the communication circuit 1 that is lower than the power of the first power source 8. For example, the first power source 8 is a socket and the communication source 14 is a landline. In other examples, the second power source may be a separate power source or be the same as the first power source 8.

The communication circuit 11 is arranged to transmit a communication 12 to the controller 4 for printing its content. In turn, the controller 4 may be configured to instruct the imaging device 2 to print content of the communication 12 based on the communication 12. In an example, the controller 4 is configured to interpret the communication 12 as, or adapt the communication 12 to, printable image data so as to instruct the imaging device 2 to print the content of the communication 12 on pre-positioned media.

The example printer 1 is arranged to have a first low power mode wherein the controller 4 is deactivated, so that substantially no power is consumed by the controller 4. In the first low power mode, the communication circuit 11 remains activated so as to be able to receive and/or transmit incoming communications 12. For example, in the first low power mode, the communication circuit 11 is configured to activate a deactivated controller 4 and transmit the communication 12 to the controller 4 for printing after receiving a communication 12. This allows the controller 4 to be cut off from power while the communication circuit 11 can receive communications 12. In an activated state, the communication circuit 11 may run at approximately 1 Watt or less, for example approximately 0.7 Watt or less, and the entire printer 1 in the first low power mode runs at approximately 1 Watt or less, for example approximately 0.7 Watt or less. Hence, the printer 1 is arranged to receive communications 12 and activate the printer 1 at a relatively low power.

The communication circuit 11 in an activated state consumes less power than the controller 4 in an activated state. For example, the voltage fed to the activated communication circuit 11 may be equal to or less than approximately 4 Volts, or equal to or less than approximately 3.3 Volts, or equal to or less than approximately 3 Volts. The Voltage for the communication circuit 11 may be provided by the communication source 14, which in an example is a landline.

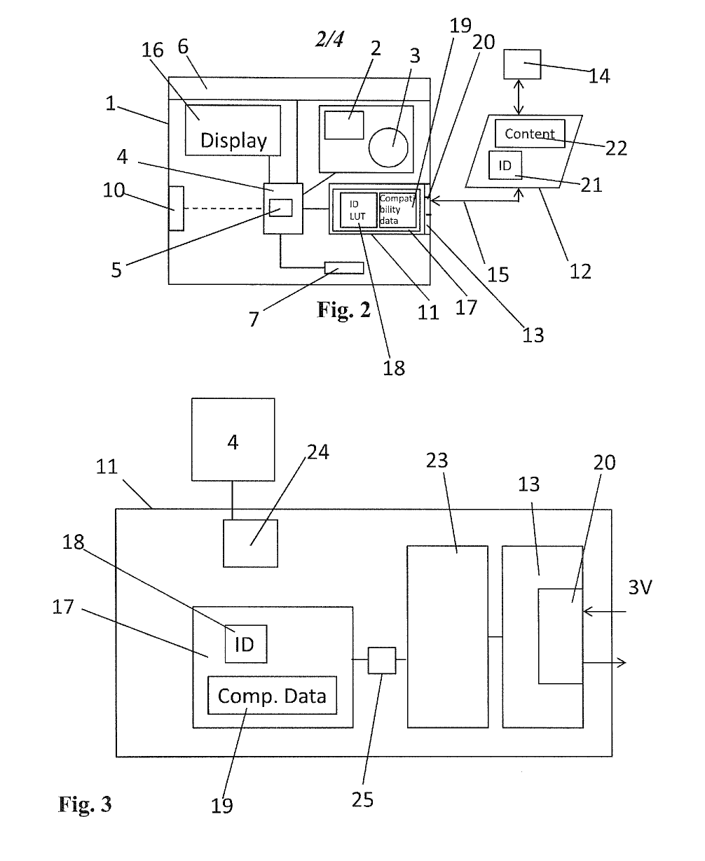

FIG. 2 shows a diagram of another example printer 1. The printer 1 includes a display 16. The display 16 functions as a graphical user interface arranged to instruct and/or be instructed by the controller 4. The display 16 may include at least one light source, and/or an array of light sources, and/or an array of resistors 16 pertaining to certain pixels. The controller 4 includes a memory 5. The controller 4 may include a digital and an analogue ASIC. The controller 4 is arranged to instruct display information on the display 16.

The printer 1 may be arranged to have a second low power mode. In the second low power mode, the display 16 may be deactivated while the controller 4 remains at least partially activated. In an example of the second low power mode, at least a light source of the display 16 is deactivated. In another example of the second low power mode, a portion of the controller 4 and the display 16 are deactivated. For example, the analogue ASIC and/or other blocks in the ASIC are at least partially deactivated in the second low power mode. For example, the controller 4 is at least partially activated to allow for reception and/or usage of digital image data through the second interface 10 for printing. For example, the controller 4 generates an interrupt signal when receiving such digital image data to fully activate the controller 4 and/or to activate the display 16 to allow printing or proceed with printing. In some instances, the second low power mode is referred to as a stand-by or sleeping mode.

The total power consumption of the printer 1 in the first low power mode is less than the total power consumption of the printer 1 in the second low power mode. The total power consumption of the printer 1 in the second low power mode is less than the total power consumption in a full operation mode of the printer. In an example, a power of the printer 1 in an off-mode is approximately 0.3 Watts or less. For example, in the off-mode both the communication circuit 11 and the controller 4 are deactivated. A digital clock or other circuit may remain active. In a further example, a power of the printer 1 in a first low power mode is approximately 1 Watt or less, or approximately 0.7 Watt or less. This power may substantially correspond to the power consumption of the communication circuit 11 to be able to receive communications 12 and activate a verification process of the communication 12.

The communication circuit 11 includes a communication interface 13 for transmitting communication signals. In an example, the communication interface 13 includes a connection circuit 20, for example for connecting the communication circuit 11 with the communication source 14, for example for connecting a communication line 15 such as a landline. In an example, the connection circuit 20 is an extension line pick up arrangement. The extension line pick up arrangement may be arranged to transmit phone call signals to an external phone, while transmitting fax signals to the communication circuit 11. The extension line pick up arrangement may include a line in, for phone and fax, and a line out for phone. When either a phone call or a fax signal is received, the extension line pickup arrangement forwards the signal to the communication circuit 11, which determines if. The communication circuit 11 may then activate the controller 4, depending on the type of signal.

In the shown example, the communication circuit 11 includes a second memory circuit 17. The second memory circuit 17 may function as a buffer for the communication circuit 11, for example storing IDs 18 and compatibility data 19 relating to communications 12. In an example, the communication circuit 11 is configured to verify if an incoming communication signal is compatible with the compatibility data 19, for example to verify if the signal corresponds to a fax signal or not. For example, the communication circuit 11 is configured to not activate the controller 4 when a phone call signal is received.

In an example, a communication 12 includes an ID 21 and content 22. For example the communication 12 may be a fax message. The ID 21 may correspond to a phone or fax number. The content 22 may include text and/or image data. The incoming ID 21 and content 22 may require decoding and may be compared to the stored IDs and/or compatibility data in decoded form.

FIG. 3 is an example of a communication circuit 11. The communication circuit 11 may be a fax circuit, or modem or other communication circuit. The shown communication circuit 11 includes a communication circuit interface 13 for receiving and/or sending communications 12 from and/or to a communication source 14. The communication circuit interface 13 includes a connection circuit 20 such as a line extension pick up arrangement. The communication circuit 11 includes a decoder 23 for decoding the communication 12. The decoder 23 may decode the communication to derive and/or decode the ID 21 and the content 22 of the communication 12. In an example, the communication circuit 11 includes a transformer 25 between the communication interface 13 and the second memory circuit 17.

The communication circuit 11 is configured to compare the communication ID 21 with the at least one stored ID 18, to determine if the controller 4 needs to be activated for printing. Furthermore, the communication circuit 11 is configured to check a compatibility of an incoming communication 12 with the compatibility information, to determine if the controller 4 needs to be activated for printing. For example, a compatibility of an incoming signal from the line extension arrangement may be verified, so that only fax signals trigger activation of the controller 4. The second memory circuit 17 may store filter data such as IDs 18 and/or compatibility data 19. The filter data may be used for filtering junk communications and/or non-compatible communications 12 such as phone calls, to prevent activation of the controller 4 when an incoming communication 12 is determined to be a junk communication or a non-compatible communication. The IDs 18 in the second memory circuit 17 may include at least one of a desired ID and an undesired ID for comparison with the incoming communication ID 21. For example, the second memory circuit 17 includes a blocked number list comprising undesired IDs.

The communication circuit 11 is arranged to activate the controller 4, for transmitting the communication 12 to the controller 4 for printing. For example, the communication circuit 11 is configured to activate the controller 4, after determining that a communication 12 is compatible and/or not junk. In a further example, it is determined that the communication is not a phone call. In a further example, the communication circuit 11 is arranged to activate the digital ASIC. The communication circuit 11 may include an interrupter 24 configured to generate an interrupt signal to activate the controller 4.

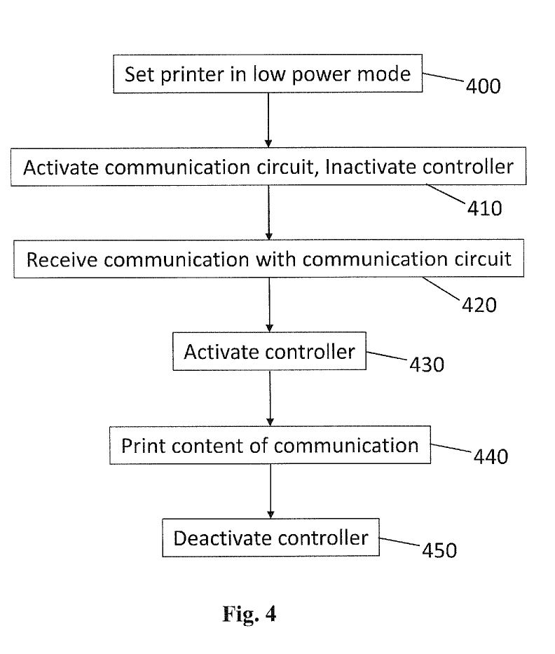

FIG. 4 shows a flow chart of an example of a method of printing. The method includes setting a printer 1 in a low power mode (block 400), for example the first low power mode, wherein the communication circuit 11 is activated while the controller 4 is deactivated (block 410). For example, if the printer 1 was in an off mode, the communication circuit 11 is activated. For example, if the printer 1 was in a full operational mode or in a second low power mode, the controller 4 is deactivated, and the communication circuit 11 remains active. At a certain point in time, the communication circuit 11 receives a communication 12 in the low power mode (block 420). The communication circuit 11 activates the controller 4 (block 430). For example, the printer 1 is switched into full operational mode for printing. A display 16 may or may not be activated. The communication circuit 11 forwards the communication to the controller 4 and the controller 4 instructs the imaging device 2 to print the content 22 of the communication (block 440). After the communication has been printed, the controller 4 may again be deactivated (block 450); the printer 1 may be reset to the low power mode.

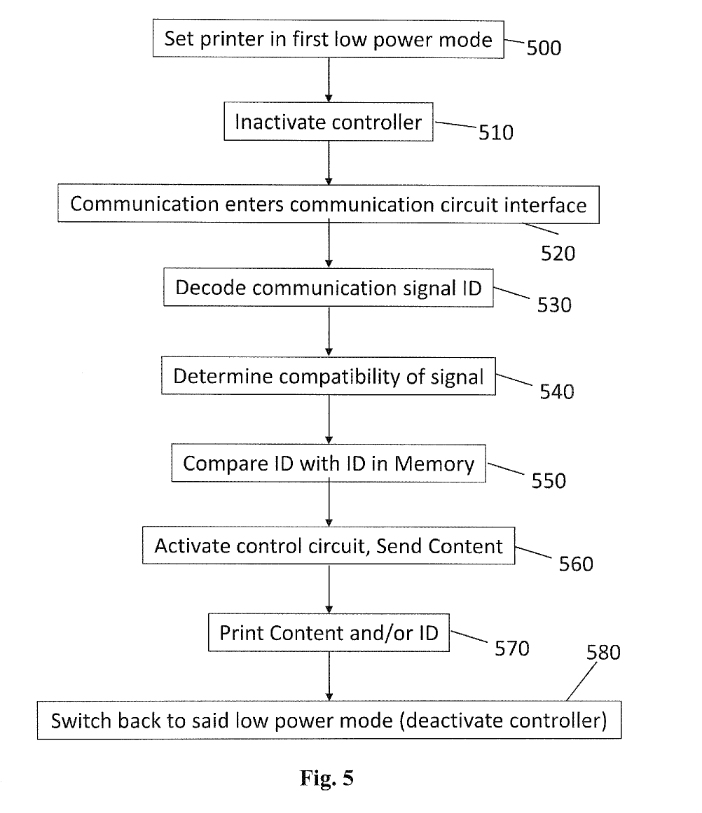

FIG. 5 shows another example of a method of printing. The example method includes setting the printer 1 in a low power mode (block 500), for example a first low power mode wherein the controller 4 is inactivated (block 510) while the communication circuit 11 is or remains activated. In an example, the communication circuit 11 includes a fax circuit or modem or the like. A communication 12 enters the communication circuit interface 13 (block 520). For example, a fax signal enters the extension line pick up arrangement through a landline. The communication 12 is decoded (block 530) by a decoder 23. For example, an ID 21 and/or content 22 of the communication 12 is decoded. The decoded content 22 may be an image or text file. A compatibility of the communication signal is determined (block 540), for example by verifying if the communication 12 matches or differs from compatibility data stored in the second memory circuit 17. For example, it is determined if the extension line signal corresponds to a fax or phone. If it corresponds to a fax, the signal may be further compared or forwarded to the controller. If it corresponds to a phone signal, the phone call is forwarded to the external telephone.

The ID 21 may be compared with the ID 18 stored in the second memory circuit 17 (block 550). For example the ID 21 is compared with a LUT or list of desired or undesired IDs. If it is determined that the communication 12 is compatible and not undesired (block 540 and 550, respectively), the control circuit 4 is be activated (block 560). The communication circuit 11 may send an interrupt signal to the controller 4, which switches on the controller 4. For example, the communication circuit 11 signals an interrupt to the digital ASIC, activating the controller 4 for printing. The content 22 of the communication 12 is sent to the controller 4 for printing. Also the decoded ID 21 may be sent to the controller 4 for printing. The controller 4 instructs the imaging device 2 to print. The content 22 and/or ID 21 are printed (block 570). In an example, the fax message is printed. After printing, a second interrupt signal may switch the printer 1 back to the first low power mode by deactivating the controller 4 (block 580).

The above description is not intended to be exhaustive or to limit this disclosure to the examples disclosed. Other variations to the disclosed examples can be understood and effected by those skilled in the art from a study of the drawings, the disclosure, and the claims. The indefinite article “a” or “an” does not exclude a plurality, while a reference to a certain number of elements does not exclude the possibility of having more or less elements. A single unit may fulfil the functions of several items recited in the disclosure, and vice versa several items may fulfil the function of one unit. Multiple alternatives, equivalents, variations and combinations may be made without departing from the scope of this disclosure.

1. Printer, comprising
a printer controller,
a memory, and
a communication circuit configured to
receive a communication from an outside source, and,
in a low power mode, activate a deactivated controller and transmit the communication to the controller for printing content of the communication.

2. Printer according to claim 1, wherein the communication circuit comprises a fax circuit.

3. Printer according to claim 1, arranged to have a first and a second low power mode, wherein
said low power mode corresponds to the first low power mode,
in the first low power mode the controller is deactivated and in the second low power mode the controller is at least partly activated,
the total power consumption of the printer in the first low power mode is less than the total power consumption in the second low power mode, and
the total power consumption of the printer in the second low power mode is less than the total power consumption in a full operation mode of the printer.

4. Printer according to claim 3, comprising a display, wherein
in the first low power mode the communication circuit is activated and the controller and display are deactivated, and
in the second low power mode the communication circuit and at least a part of the controller are activated and the display is deactivated.

5. Printer according to claim 1, wherein the communication circuit is arranged so that a total power consumption of the printer in the low power mode is equal to or less than approximately 1 Watt.

6. Printer according to claim 1, wherein the controller is configured to self-deactivate after printing said content.

7. Multifunctional printer according to claim 1, wherein the communication circuit comprises a communication circuit interface for receiving the communication from the outside source, and the printer comprises a second data interface, and
an imaging device, wherein
the second interface is arranged to receive digital image data, and
the controller is configured to
instruct the imaging device to print based on the digital image data, and
instruct the imaging device to print based on content of the communication.

8. Printer according to claim 1, wherein
the communication circuit comprises a memory circuit,
the memory circuit includes compatibility data, and
the communication circuit is configured to check compatibility of an incoming communication with the compatibility data, to determine if the controller needs to be activated for printing.

9. Printer according to claim 1, wherein
the communication circuit is arranged to receive a communication including an ID,
the communication circuit comprises a memory circuit storing at least one of a desired ID and an undesired ID for comparison with the communication ID, and
the communication circuit is configured to compare the communication ID with the at least one stored ID, to determine if the controller needs to be activated for printing.

10. Printer according to claim 1, wherein the communication circuit comprises an extension line pickup arrangement, arranged to connect to a landline, and configured to
signal the communication circuit when a communication is received, and
transmit phone calls to an external phone.

11. Method of printing, comprising,
switching to a low power mode of a printer so that a communication circuit is activated and a printer controller is deactivated,
the communication circuit receiving a communication in the low power mode,
the communication circuit activating the printer controller,
printing content of the communication, and
switching the printer back to said low power mode.

12. Method according to claim 11, wherein the communication comprises content and an ID, comprising, in the low power mode,
comparing the ID with at least one stored ID, and
activating the controller based on the comparison.

13. Method according to claim 11, comprising, in the low power mode,
determining a compatibility of the communication, and
activating the controller if the communication is compatible.

14. Method of printing according to claim 11, wherein the communication comprises a fax signal.

15. Printer, comprising
a controller, comprising a processing circuit memory, and
a communication circuit,
wherein the communication circuit is configured to
remain active in a low power mode wherein the controller is inactive, and
when receiving an incoming communication in the low power mode, generate an interrupt to activate the controller, for printing content of the communication.
